(19) United States
(12) Patent Application Publication
(10) Pub. No.: US 2011/0320943 A1
(43) Pub. Date: Dec. 29, 2011

(54) Process and Apparatus for Computer Training

(75) Inventors: John Wade, Lindon, UT (US); Derek Adams, Highland, UT (US); Christopher Mascis, Seattle, WA (US); Clayton Erickson Farr, Alpine, UT (US); Jeff House, Redmond, WA (US); Robert Barker, JR., Kirkland, WA (US); Casey Margell, Seattle, WA (US)

(73) Assignee: Brainstorm, Inc., American ForK, UT (US)

(21) Appl. No.: 12/826,410

(22) Filed: Jun. 29, 2010

(51) Int. Cl. G06F 3/01

(52) U.S. Cl. 715/708

(57) ABSTRACT

An adaptive and interactive training system and method is provided. The system provides training content to a user of an application program based upon a variety of factors. The system selects the training content based upon the user's individualized needs vis-à-vis an application program. The system may customize the training sent to the user by evaluating the user's actual interaction with the application program, the user's personal profile and the group profile of groups to which the user belongs.

### BACKGROUND OF THE INVENTION

It is currently understood that users of application programs often require training to improve their efficiency operating the application program. Often the training is limited to use of a help button in the application program. Pressing the help button presents a menu from which the user can select topics for which helpful suggestions are provided. The help suggestions often take the form of written directions. In some applications, video content is provided that teaches an application user how to utilize features of the application program.

Additionally training may occur independent of the help function in an application program. Such training may occur through live training sessions where an individual may teach a group or individual users of an application program how to use the features of the application program. Also, tools may be purchased separate from the application program. Users may acquire training material in the form of books or DVDs that explain the functionality of an application program and provide training to a user through self-training.

Users may also find training on the Internet. The training may come from the application program source or from third parties. For example, training videos for many application programs may be found at ehow.com or youtube.com.

The prior training methods, while helpful, do not take into account the unique training needs of each individual user. Training content is presented to one user just as it is to another, and in fact, to all users.

### SUMMARY OF THE INVENTION

Aspects of the present invention enable a system to be customizable to an individual user. Training content is provided to the user based on the user's actual interaction with an application program. When the user requests help through the application program, related topics may be suggested. A user's job description may dictate training received and may enable a system to customize training content to fit the needs of the user. Additionally, in some embodiments, tracking the global use of training content and application program functions will further enable the system to refine the nature of the content received by an individual user based upon his or her personal profile and the observed user's interaction with the application program.

In one embodiment, a training system is provided. The system has a monitoring function embeddable in an application program. The monitoring function is capable of identifying features of the application program that are utilized. The system has a programmed processor in electronic communication with the application program such that the application program is capable of conveying data gathered by the monitoring function to the programmed processor. The system has an electronic training library accessible by the programmed processor. The electronic training library contains content relating to use of the application program features and the programmed processor is capable of selecting content from said training library based, at least in part, on the data obtained from monitoring the use of the application program. The programmed processor also is capable of causing the electronic conveyance of the content to a user of the application program.

In one embodiment, a training system is provided. The system has a monitoring function embeddable in an application program. The monitoring function is capable of identifying features of the application program that are utilized. The system has a programmed processor in electronic communication with the application program such that the application program is capable of conveying data gathered by the monitoring function to the programmed processor. The system has an electronic training library accessible by the programmed processor. The electronic training library contains content relating to use of the application program features and the programmed processor is capable of selecting content from said training library based, at least in part, on the data obtained from monitoring the use of the application program. The programmed processor also is capable of causing the electronic conveyance of the content to a user of the application program. The system has an electronic database containing information about the use of the application program by multiple users and the programmed processor is capable of selecting the content from the training library based, at least in part, on the information from the electronic database.

In one embodiment, a training system is provided. The system has a monitoring function embeddable in an application program. The monitoring function is capable of identifying features of the application program that are utilized. The system has a programmed processor in electronic communication with the application program such that the application program is capable of conveying data gathered by the monitoring function to the programmed processor. The system has an electronic training library accessible by the programmed processor. The electronic training library contains content relating to use of the application program features and the programmed processor is capable of selecting content from said training library based, at least in part, on the data obtained from monitoring the use of the application program. The programmed processor also is capable of causing the electronic conveyance of the content to a user of the application program. The system utilizes a user profile comprising facts about a specific user. The programmed processor is capable of selecting the content from said training library based, at least in part, on the facts from the user profile.

In another embodiment, the system's programmed processor is capable of updating the user profile with new facts about the specific user's interaction with the application program.

In one embodiment, the programmed processor is capable of updating the user profile with new facts about the specific user's interaction with the training library.

In one embodiment, the training library content includes a plurality of video presentations.

In another embodiment, the programmed processor is capable of creating reports relating to the user profile.

In one embodiment, the programmed processor is capable of conveying material to a user in response to external prompts. In another, the material is found in the training library.

In one embodiment, a training system is provided. The training system has a programmed processor in electronic communication with an application program. The system utilizes a user profile comprising facts about a specific user. The system also has a training library accessible by the programmed processor. The training library contains content relating to use of the application program features. The programmed processor is capable of selecting content from the training library based, at least in part, on the facts from the user profile and is capable of electronically conveying the content to a user of the application program.

In one embodiment, a training system is provided. The training system has a programmed processor in electronic communication with an application program. The system utilizes a user profile comprising facts about a specific user. The system also has a training library accessible by the programmed processor. The training library contains content relating to use of the application program features. The programmed processor is capable of selecting content from the training library based, at least in part, on the facts from the user profile and is capable of electronically conveying the content to a user of the application program. The system also has a general user database containing information about the use of the application program by multiple users; the programmed processor is capable of selecting content from the training library based, at least in part, on information from the database. The programmed processor is capable of electronically conveying the training library content to a user of the application program.

In another embodiment, a training system is provided. The training system has a programmed processor in electronic communication with an application program. The system utilizes a user profile comprising facts about a specific user. The system also has a training library accessible by the programmed processor. The training library contains content relating to use of the application program features. The programmed processor is capable of selecting content from the training library based, at least in part, on the facts from the user profile and is capable of electronically conveying the content to a user of the application program. The features of the application program that are utilized are monitored and data relating to the monitored tracked features is conveyed to said programmed processor.

In one embodiment, a training system is provided. The training system has a programmed processor in electronic communication with an application program. The system utilizes a user profile comprising facts about a specific user. The system also has a training library accessible by the programmed processor. The training library contains content relating to use of the application program features. The programmed processor is capable of selecting content from the training library based, at least in part, on the facts from the user profile and is capable of electronically conveying the content to a user of the application program. The system also has a general user database containing information about the use of the application program by multiple users; the programmed processor is capable of selecting content from the training library based, at least in part, on information from the database. The programmed processor is capable of electronically conveying the training library content to a user of the application program. The application program is programmed to track features of the application program that are utilized and the application program is capable of conveying data relating to the tracked features to said programmed processor the programmed processor is capable of selecting content from the training library based, at least in part, on the data. The programmed processor is capable of electronically conveying the content to the application program.

In another embodiment, a training method is provided. The method comprises electronically monitoring the use of an application program to identify use patterns of the application program. A programmed processor is used to utilize the identified use patterns to select content relating to the application from an electronic training library and being usable to train a user of the application program to better utilize features of the application program. The selected content is electronically conveyed from the electronic training library and is presented to the user of the application program such that the conveyed selected content may be used to train the user to better utilize the features of the application program.

In another embodiment, a training method is provided. The method comprises electronically monitoring the use of an application program to identify use patterns of the application program. A programmed processor is used to utilize the identified use patterns to select content relating to the application from an electronic training library and being usable to train a user of the application program to better utilize features of the application program. The selected content is electronically conveyed from the electronic training library and is presented to the user of the application program such that the conveyed selected content may be used to train the user to better utilize the features of the application program. The programmed processor, at least in part, uses a user profile to select content from the electronic training library.

In another embodiment, a training method is provided. The method comprises electronically monitoring the use of an application program to identify use patterns of the application program. A programmed processor is used to utilize the identified use patterns to select content relating to the application from an electronic training library and being usable to train a user of the application program to better utilize features of the application program. The selected content is electronically conveyed from the electronic training library and is presented to the user of the application program such that the conveyed selected content may be used to train the user to better utilize the features of the application program. The programmed processor, at least in part, uses a user profile and a general user database to select content from the electronic training library.

In one embodiment, a training method is provided. An electronic training library is organized. The electronic training library contains content relating to an application program and is usable to train a user of the application program to better utilize features of the application program. The content is electronically conveyed to a user after having been selected from the electronic training library by a programmed processor. The programmed processor utilizes information about a user's interaction with the application program to select the conveyed content from the electronic training library.

### BRIEF DESCRIPTION OF THE DRAWINGS

FIG. 1 is a schematic depicting multiple user stations, a server, a training content library database, a user profile database and group profile database.

FIG. 2 is an example of a personal profile.

FIG. 3 is an example of a group profile.

FIG. 4 is a flowchart depicting the analysis arising from input of a user profile.

FIG. 5 is a flowchart depicting an example analysis related to monitoring of a user's interaction with an application program.

FIG. 6 is a flowchart describing the decision making process of determining whether the content is appropriate for a user.

FIG. 7 is a conceptual model of a system used to customize training for an application program user.

### DETAILED DESCRIPTION OF THE INVENTION

This disclosure is intended to describe the novel features of the claimed invention. Those who are skilled in the art will recognize alternate equivalent methods and devices for customizing training content for an application program user upon reading this disclosure.

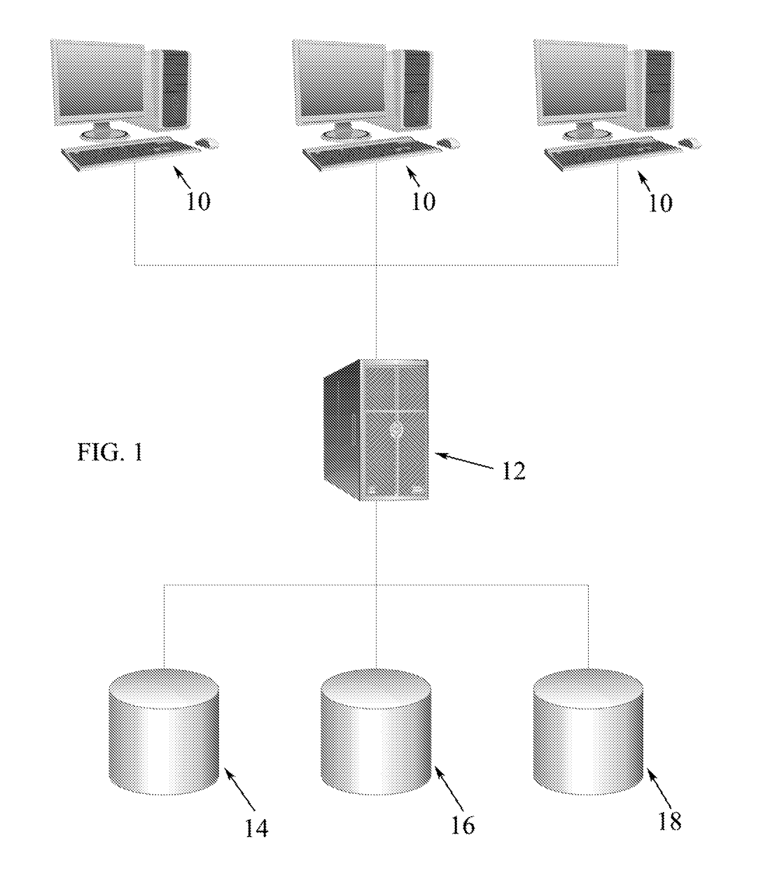

FIG. 1 is a schematic of a network used to implement an embodiment of the present invention. User stations 10 are in electronic communication with a server 12. The user stations 10 have a processor programmed to run an application program such as a word processing program or a spreadsheet program or a graphic presentation program or an architectural design program or a digital imagining manipulation program. The invention is not limited to a specific application program and the application programs mentioned are by way of example only. As used herein, application program means any computer program with which a user might interface and which performs a function such as, but not limited to, those described above.

FIG. 1 depicts a distributed system where workstations 10 interact through a server 12 with a content library database 14, a user profile 16 database and a group profile 18 database. The system depicted could be compressed and could work within a standalone user station 10 with Internet, or other electronic access to other computers. In such a configuration, the content library database 14, user profile 16 database and group profile 18 database could be contained on the standalone user station 10. In such a configuration the content library database 14, user profile database 16 and group profile database 18 would be downloaded to the individual user station 10 with the training program. Also, in certain applications, the application program could be remotely accessed by the user station.

In one aspect of the claimed invention, the application program has an add-in or ribbon that interacts with the training system. The add-in may monitor a user's interaction with the application program. In some instances the add-in may record actual user keystrokes. In other instances, the add-in may track application program function usage. The add-in may report the tracked interaction with the application program to the training system. Through the add-in, the training system can monitor the proficiency of a user and can accurately assess the efficacy of training received by measuring the user's proficiency improvement. Additionally, the add-in may direct help queries from the user in the application program to the training program. Responsive content from the training program may be delivered to the user through the application program add-in. The add-in may track the history of the content viewed by a user and permit a user to mark content for future use. Through the add-in, users may request development of content on specific topics. Additionally, the add-in may help a user identify helpful content by presenting galleries of the most watched content and content currently being accessed by other users.

In the configuration depicted in FIG. 1, server 12 contains a processor configured to implement the claimed invention. Content library 14 is a database containing training content. The training content may include written instructions or instruction that are presented audibly and/or visually. In one embodiment, the content library 14 includes a plurality of video clips that may be used to train an application program user.

In one embodiment, content is added to the library 14 based upon user interaction with the library. For example, if a certain type of content or content format is highly ranked by users, additional content of that type or format may be added. A user might request specific content as well. If users are not satisfied with content relating to certain aspects of the application program, additional content might be added to better address the user's needs. Content that is ineffective may be removed from the library 14.

In the embodiment depicted in FIG. 1, a user at one user station 10 could recommend helpful content to a user at another user station 10. Additionally, the interaction of all of the users with the system may be instantaneously incorporated into the system. For example, a user could be informed about content currently being viewed by other users. Such might expose the user to relevant content the user might otherwise overlook. In this embodiment, the training system evolves with use to better target content to an individual user's needs.

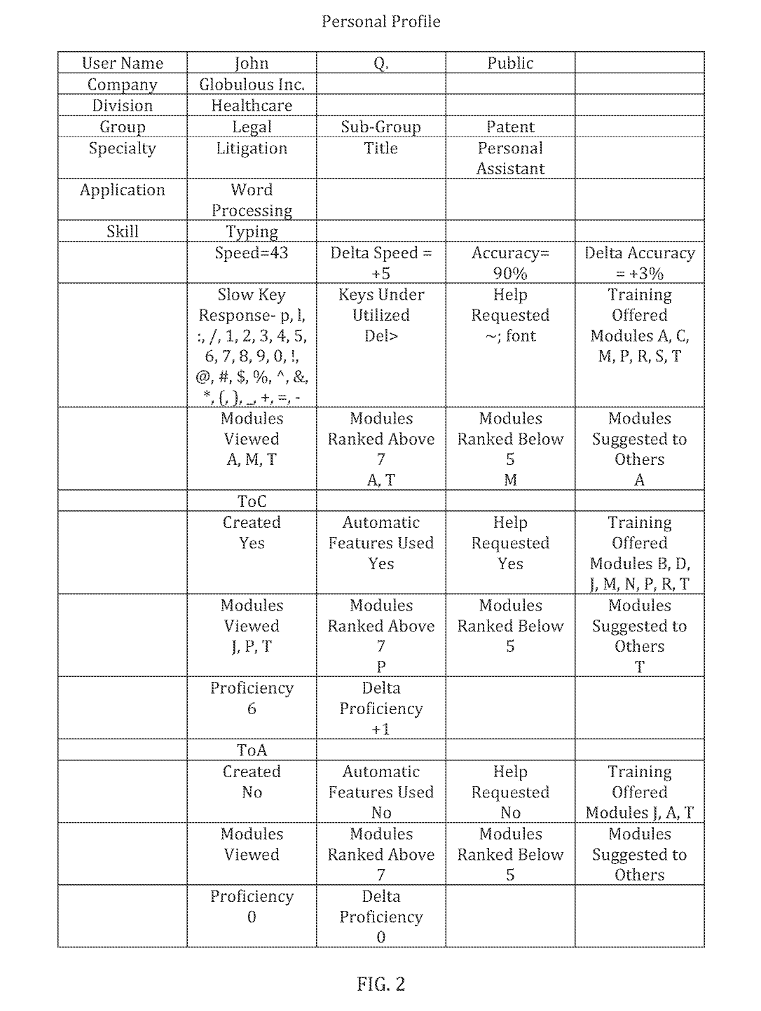

An example of a user's personal profile is depicted is FIG. 2. The user profile database 16 contains information specific to each application program user. Such could include information like that found in the personal profile depicted in FIG. 2. That said, FIG. 2 is illustrative only. The actual information collected in a personal profile will vary widely depending upon a variety of factors that may include the nature of the user's business, the application programs used and the specific training needs identified by the business.

In the personal profile depicted in FIG. 2, the user is identified as being in the Globulous Inc. healthcare division and as being in the patent sub-group of the legal group with a specialty in litigation. The personal profile also indicates that the user is a personal assistant.

This information, as will be discussed more fully below, enables the selection of training content suitable for use by a personal assistant working in litigation in the patent group of a healthcare company. For example, it might be contemplated that one working with a word processing application program in the healthcare industry would have a need for an enhanced dictionary of medical terms, might need training for how to create a dictionary of specialized terms or might need training on how to find the definition for the specialized terms through available resources.

Someone working in litigation may have a need for word processing skills used for tasks that are litigation related. For example, training relating to properly blue booking citations, creating a Table of Authorities, creating a Table of Contents, creating footnotes, specialized headers and other requirements unique to a litigation practice may be desired. The general information about the user can be used to tailor training content to a particular user's needs based upon the likely use of the application program by that user.

Also, information about the users employer may be used to tailor training content for the user. In the example of FIG. 2, Globulous Inc. employees may find particular training helpful. More specifically, Globulous Inc.'s Healthcare Division employees may have unique training needs. It is contemplated that the personal profile could be used to monitor application program usage and the interactions of groups with the training system to customize training to individual users. By monitoring individuals at Globulous Inc. and its Healthcare Division, patterns of use may suggest training helpful to others at Globulous Inc. generally or the Healthcare Division specifically.

The personal profile, as depicted in FIG. 2 may also include specific information about a user's actual interaction with an application program. For example, in FIG. 2, through monitoring a user's particular interaction with an application program it has been determined that the user has a typing speed of 43 words per minute and that that typing speed has increased 5 words per minute during the time that the user has had access to training content. It was also determined that the user has a 90% accuracy rate and that the accuracy has increased by 3% since the user has had access to the training content. The user had a slower response when using certain keyboard features as compared to use of other features. It has also been determined that the user underutilizes the reverse delete key. The user has requested Typing help from the help function of the application program for creation of “˜” and for font modifications. This information comes from the users interaction with the application program used and may be recorded by the actual application program or a separate program monitoring the application program's use. The personal profile may be updated periodically with the information collected from actual use.

The personal profile depicted in FIG. 2 also indicates that this particular user has been offered Typing content and has viewed three distinct Typing content modules. The personal profile indicates that the user has taken the opportunity to rank two of those modules above seven on a scale of one to ten. The user ranked one module below five. The user has suggested Typing Training Module A to other users. Content usage may be monitored at the user station 10 or by the server 12 in the configuration depicted in FIG. 1.

The personal profile depicted in FIG. 2 shows that the user has created a Table of Contents with the automatic table creation features of the application program. The personal profile records that the user requested help and was offered a variety of Table of Contents training modules. The user viewed three of the Table of Contents training modules offered and ranked one of the modules above a seven on a scale of one to ten. No modules were ranked below five and the user suggested one module to another user. Additional information about the users interaction with the training content might also be recorded. For example, it might be helpful to know if the user interacted with the same content multiple times or if the user selected a module but did not watch the entire module.

In the personal profile of FIG. 2, the user's interaction with the application program indicates that the user has a proficiency of six on a scale of one to ten with the Table of Contents feature of the application program and the user's efficiency has increased by one since having interaction with training content. Numerous other parameters could also be tracked. For example, it might be advantageous to a business to know how often a user creates a Table of Contents, how often an application program's automatic features are used, how often help is requested and on what topics and so on.

Table of Authorities usage is monitored in the personal profile of FIG. 2. The personal profile indicates that a Table of Authority has not been created by the user and that the automatic features for Table of Authority have not been used. No help has been requested for Table of Authorities. The personal profile also suggests that three Table of Authorities training modules were offered to this user but that no modules were viewed. This particular user was given a proficiency rating of zero for the Table of Authorities function.

FIG. 2 is illustrative of the information that can be kept in a personal profile. The content of the personal profile will be modified depending upon the user's group, sub-group, specialty and title. For example, an engineer in the Globulous Inc. Healthcare Division would likely have no need for Table of Authority creation training but may desire training with a presentation, 3D modeling or flow chart creation application program. Word processing skills are likely much less relevant to an engineer than skills associated with modeling or project management application programs. Likewise, a graphic artist in the Healthcare Division would likely be more interested in training about the features of a graphic design application program than a flow chart creation application program. A personal assistant with a litigation specialty may find Table of Authorities training helpful while a personal assistant with a marketing specialty likely would not. The personal profile is updated periodically to reflect the user's current job assignment, training and skill as well as usage of application program features.

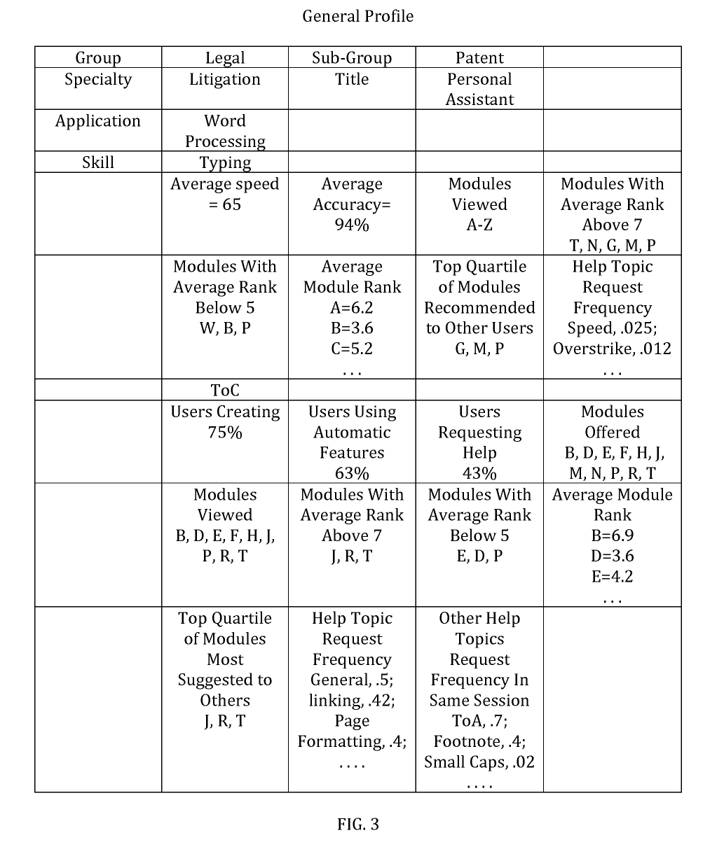

An example of a general profile is depicted in FIG. 3. The general profile is an aggregate of usage monitored by user stations 10 and content accessed by users of those stations. The general profile of FIG. 3 is focused on personal assistants in patent litigation. Personal assistants in the patent litigation group have an average typing speed of 65 words per minute and an accuracy of 74%. The general profile includes the Typing training modules that have been viewed by the group, the modules average user ranking and highlights the modules that have an average ranking above seven and modules that have an average ranking below five. The general profile lists the modules most recommended to other users in the patent litigation/personal assistant sub-group. The general profile of FIG. 3 also records the Typing help topics requested by frequency.

A portion of the general profile of FIG. 3 focuses on Table of Contents usage. Among the personal assistants in the patent litigation group, 75% of the users are creating Table of Contents, 63% of the users are using automatic features of the application program to create Table of Contents and 43% of the users are requesting help in creating Table of Contents. A listing of the Table of Contents training modules that have been offered to users is depicted. A list of the modules actually viewed is recorded along with the module's average ranking and a listing of the modules ranked highly and poorly by users. The modules most suggested to others are also recorded.

The general profile lists the frequency with which personal assistants in the patent litigation group access application program help topics relating to the application program's Table of Contents function. Additionally, the frequency with which the group accesses help topics that are not directly related to the Table of Contents function in the same sessions is recorded.

As with the personal profile of FIG. 2, the general profile of FIG. 3 is illustrative only. Many distinct general profiles could be contemplated in implementing the invention. The general profile may focus on an entire organization or any sub-group of the organization. The general profile could include information about all users of the invention, regardless of business affiliation. Individual elements of the general profile may vary. FIG. 3 presents a small, illustrative example of what might be included in a general profile.

From the general profile, it can be determined that in the typing group modules T, G, M and P are ranked highly and therefore they might be suggested to users in the personal assistant/patent litigation group. It might also be suggested that users in the personal assistant/patent litigation group review modules T, G, M and P because those modules are most recommend to other similar users.

In the Table of Contents section of the general profile, it can be seen that 25% of the users in the personal assistant/patent litigation group are not using the Table of Contents features of an application program such that would suggest that training on Table of Contents features might be desirable. Only 63% of the users depicted in FIG. 3 are using the automatic features of an application program to create a Table of Contents, which again suggests that Table of Contents training may be desirable. In the general profile, certain Table of Contents training modules are ranked highly and have been suggested to other users, which would suggest that these modules are appropriate for distribution to users in the patent litigation/personal assistant group.

The general profile indicates that users in the patent litigation/personal assistant's group have requested help with linking and page formatting when dealing with Table of Contents creation at a fairly high frequency. Such would suggest that training in those areas is appropriate and should be pushed to the users when creating Table of Contents.

It is also noted that patent litigation/personal assistants are requesting help, with relatively high frequency, for Table of Authorities creation in the same session when Table of Contents are created and that they are also requesting help with creation of footnotes with some frequency. Such suggests that an application program user in the patent litigation/personal assistant group would likely be interested in content relating to Table of Authorities creation and footnote creation if the user is creating Table of Contents. The system would push this training content to the user when the system detected that a user was creating a Table of Contents.

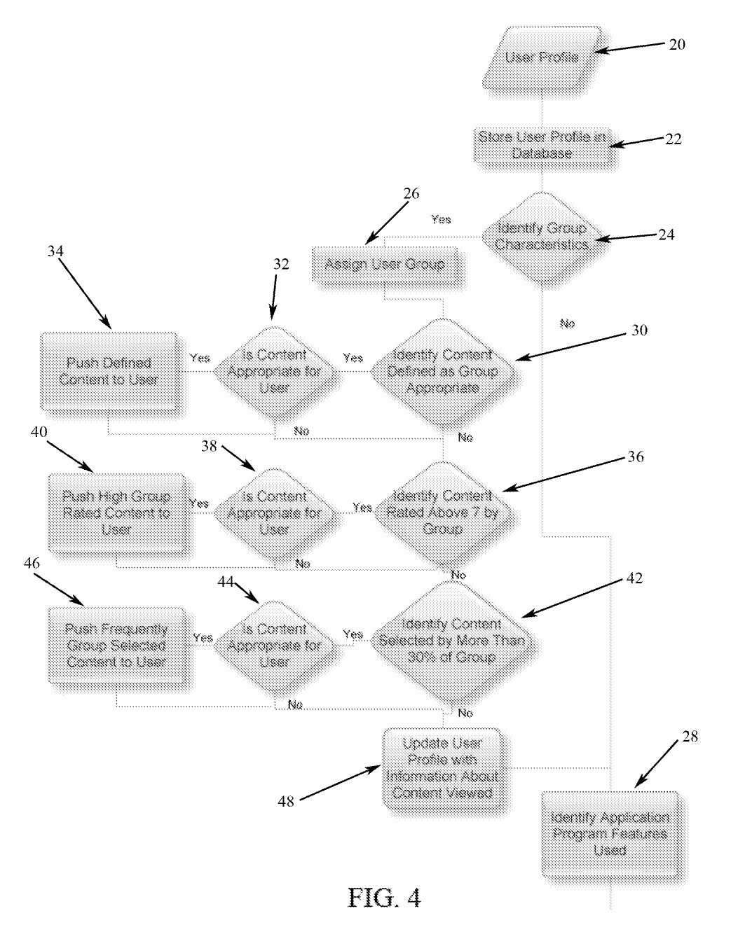

FIG. 4 is a flowchart illustrating how an aspect of the present invention might be used to improve training received by a user of an application program. In the flowchart in FIG. 4, the user profile 20 is entered. The user profile 20 is stored in a user profile database 16. The group characteristics of the user are identified 24 and, if the user belongs in a group, the user is assigned 26 to one or more user groups. If the user does not belong in a group, the group related decisions are skipped and the application program features utilized by the user are identified 28.

Once the user is assigned to a user group, the processor programmed to perform aspects of the present invention scans the training content library 14 to identify content that has previously been defined as appropriate for the group or groups to which the user has been assigned 30. If content is found that is appropriate for the user group, another analysis 32 is performed to determine whether the content is appropriate for the specific user. An example of how the system might determine whether the content is appropriate will be discussed later. If the content is determined 32 to be appropriate for the specific user, the content defined as being group-appropriate is then pushed 34 to the user at user station 10 and the user can choose to view the content when it is presented or the user may opt to view the content at a later time.

If no content is identified as group appropriate at decision 30 or if the content is not appropriate for the user 32 or after the group appropriate content is pushed 34 to the user, the system next scans the content library 14 and the group profile 18 to determine if there is content rated above a seven by this group 36. If such content is identified, it is determined if the content is appropriate for the specific user 38. User appropriate content is pushed 40 to the individual user and the user can view the content when it is delivered or can delay its viewing for a later time.

If no content is identified as being rated above 7 by the group 36 or if the content is not appropriate for the user 38 or after the highly rated content is pushed 40 to the individual user, the system next scans the group profile 18 to determine if there is content that has been selected by more than 30% of the group for viewing 42. The system next determined if the identified content is appropriate for the specific user 44. Appropriate user content is pushed 46 to the specific user and he or she can review the content when delivered or delay review until a later date.

If no content is identified as being selected by more than 30% of the group 42 or if the content is not user appropriate 44 or after the frequently selected user content is pushed 46 to the user, the user's personal profile is updated 48 with information about the content viewed, any rankings that might have been given to the content viewed, whether content viewed was suggested to others and so on.

The general profile would be updated concurrently with the personal profile with group appropriate information. For example, if the user ranked content, the average content rank in the general profile would be adjusted appropriately. If content were viewed, the general profile would be adjusted to reflect that a group member had viewed the content and so on.

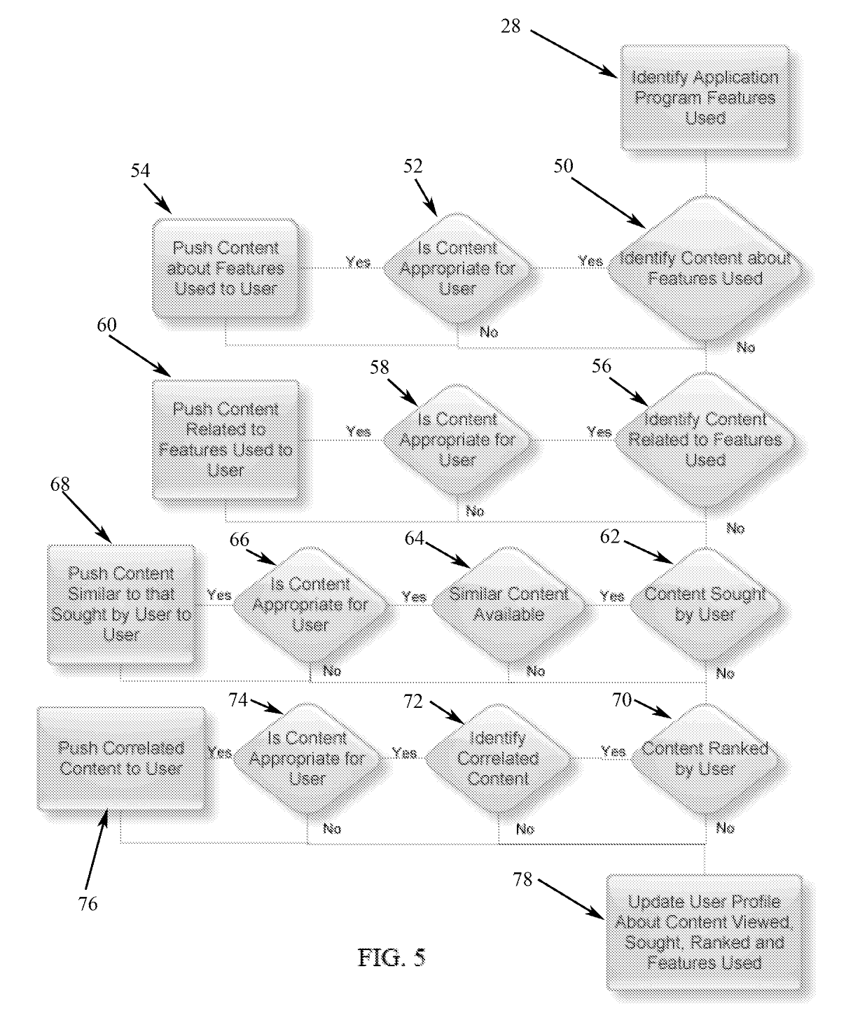

FIG. 5 depicts a flowchart for how an embodiment of the present invention would utilize information retrieved from user station 10 as an application program is being used. The information could be retrieved through an add-in or ribbon that works as part of the application program. As a first step, the content library 14 would be scanned to identify content about the feature used 50. For example, if the Table of Contents feature were utilized by a user of the application program, the content library 14 would be searched for training content relating to the Table of Contents. It would next be determined if the content identified is appropriate for the user 52. Again, user appropriateness will be discussed below. If the content is appropriate for the user, it is pushed 54 to the user while the user is using the feature of the application program.

If no content about the feature used is identified 50, if the content is not appropriate for the user 52 or after the content is pushed 54, content related to the features used in the application program is identified 56. For example, if Table of Contents is used in the application program, a related feature might be creation of a Table of Authorities. Once content about related features are identified, it is determined whether the content is appropriate to the specific user 58 and if so, the content relating to the actual feature used is pushed 60 to the user.

In one embodiment of the invention, the training system would interact with the application program such that when a user requested help through the application program, the training system would be alerted and could immediately supply responsive content to the user through the application program. The user could be completely unaware of the source of the content presented. The User's personal profile and general profile would be updated with information relating to the user's request and the content provided.

If no content related to the features of the application program being used are identified 56, if content identified is inappropriate for the user 58 or after the content about related features is pushed to a user 60, it is determined if the user has sought content 62. For example, if a user sought help for creating a Table of Contents, as noted above, the requested content would immediately be pushed to the user. Once the requested content was pushed to the user, one aspect of the invention would look to the general profile and determine that others in the user's group that sought help with Table of Contents creation also sought help with linking, page formatting, creation of Table of Authorities and footnote. If such content is available 64 and, if the content is deemed appropriate for the specific user 66, it is pushed 68 to the specific user. The user can view the content concurrently with use of his application program or delay viewing to a future time.

If content is not sought by a user 62, similar content is unavailable 64, if the content is inappropriate 66 or if the content has been pushed, it is determined if the user has ranked training content 70. If so, the general profile is accessed to determine if individual users that rank the same content highly also ranked other content highly. The content that was also ranked highly by users of the highly ranked content is identified 72. If the content is appropriate for the specific user 74, it is pushed 76 to the user and the user can view the content concurrent with his use of the application program or at a later time.

If content is not ranked by the user 70, no correlated content is identified 72, the content in inappropriate for the user 74 or if the content has been pushed to the user 76, the user profile is updated about content viewed, sought, ranked and the features used. Also the general profile is updated as appropriate.

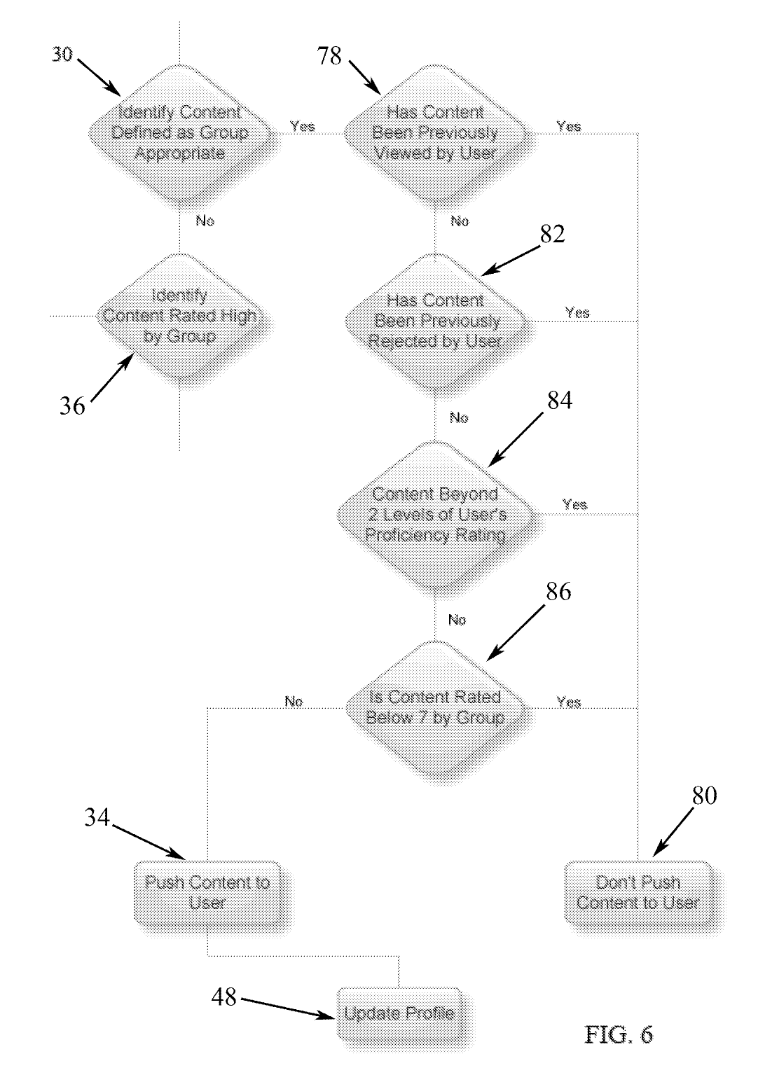

FIG. 6 depicts a flowchart for determining whether content is appropriate for a specific user. The flowchart expands block 32 from FIG. 4. Once the content is identified as group appropriate 30, it must be determined if the content is appropriate for a specific user. An example of some factors used in a user appropriateness analysis is depicted. If it is determined the user previously viewed the content 78, the content is not pushed to the user 80. If the content was not previously viewed 78, it is determined whether the user previously rejected the content 82. If so, the content is not pushed 80, if not, it is determined if the content is within two levels of the user's proficiency rating 84. If the content is more than two levels above or below the user's proficiency rating, the content is not pushed 80. If the content is within two levels of the user's proficiency rating, It is determined if the content is rated below 7 by the user's group 86. If the content is rated above 7 by the user's group, the content is pushed to the user and the user's profile and general profile will be updated 48. If the content is rated below 7 by the user's group, it is not pushed to the user 80.

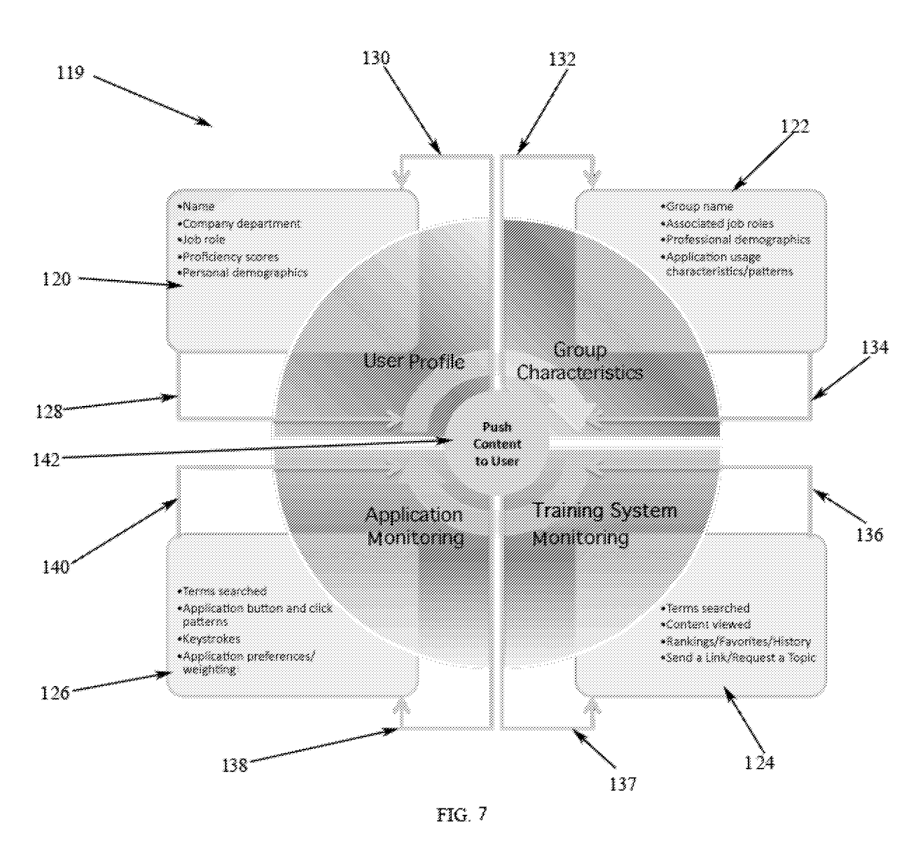

The flowchart depicted in FIG. 6 is offered by way of example only. Numerous factors will determine whether content is appropriate for any given user. Additionally, the flowcharts and structure depicted in FIGS. 1-6 are intended to be illustrative only. Alternative structures and methodologies to practice the disclosed invention will be readily apparent to those of skill in the art. Different physical structures may be used to practice the invention. For example, FIG. 7 depicts a system with four files or databases for tracking information used in the training system. The factors considered in any analysis can vary widely. In some instances, information about a user's actual interaction with the application program may be omitted from the analysis. In others, a group profile may not be available. Given the principles and objectives disclosed, the invention will be readily adaptable to address numerous training needs.

While flowcharts are used to describe aspects of the claimed invention, flowcharts may unduly limit the ability to express the nature of the invention. In one embodiment of the invention, a Bayesian optimization algorithm evaluates available information to identify the most appropriate training materials to offer a user. In this embodiment, the system is adaptive and improves with use. FIG. 7 is a schematic representation of aspects of the claimed invention. Inputs to the training system 119 include a user profile 120, group characteristics file 122, training system monitoring 124 and application program monitoring 126. The actual inputs depicted in FIG. 7 are exemplary only. In this embodiment, link 128 supplies information from the user profile 120 to the system 119. Link 130 is used to update the user profile 120. Link 132 updates the group characteristics file 122 and link 134 supplies information from the group characteristics file 122 to the system 119. Link 136 supplies information from the training system monitoring file 124 to the system 119 and is updated via link 137. Link 138 updates the application program monitoring file 126 and link 140 supplies data from the application monitoring file 126 to the system 119. An example of how one aspect of the invention is implemented follows.

A user completes his or her user profile 120. The data entered into the user profile 120 is conveyed to the system 119 via link 128. Data from the user profile 120 may prompt the system 119 to push training content to the user via link 142. For example, the user's company may designate that users with certain personal demographics will receive certain training or that all employees of a certain department will receive identified training If such training is provided, link 130 is used by the system 119 to update the user profile 120.

The system 119 updates the group characteristics file 122 with data entered by the user via link 132. The group characteristics file 122 may include demographic information about the users in the group. Thus, the user profile 120 may provide information to update group demographics. Also, the user profile 120 may identify the user's job function. The job functions associated with members of the group may be information tracked in the group characteristics file 122. Link 134 provides the system data from the group characteristics file 122.

In one embodiment, a training system monitoring file 124 is maintained. In our example, the training system monitoring file 124 would be updated via link 137 with information about the user's interaction with the training content provided. The training system monitoring file 124 tracks the training content viewed, any ranking given to the content and, the content one user recommends to another. The training system may also be queried. The training system monitoring file 124 tracks the terms searched in the training system by queries. Link 136 provides the information from the training system monitoring file to the system 119.

The application program monitoring file 126 includes information gleaned from a users actual use of the application program, including the application program help topics queried, application program features utilized and the application programs preferred by users. Link 140 supplies the system 119 with data about a user's interaction with an application program. Link 138 updates the application program monitoring file 126 as the user interacts with the application program.

Information from the application program monitoring file 126 may be included in an individual user profile 120 and may be part of the group characteristics file 122. Similarly, information from the training system monitoring file may be included in an individual's user profile 20 and may be part of the group characteristics file 122.

In one embodiment, a user profile 120 may place a user in a group with an established group characteristics file 122. The history of the group, as established by gathering information from the application monitoring file 126 for users in the group, may suggest that members of the group are heavy users of a photo editing application program and frequently use tools to remove parts of images from the foreground of one photograph and to paste the removed image segments into another photograph. The group characteristics file may also collect information from the training system monitoring file 124 for individuals in the group. Such may suggest that members of the group frequently search for content relating to the cut and paste function; that module M is the most viewed module by the group relating to that function; that module L is this cut and past module ranked highest by the group; and, that module P is the cut and paste module most recommended to other users. The user profile 120 may indicate the user has previously viewed module L. Upon receipt of such information from the user profile 120 and group characteristics file 122, the system 119 could push training modules M and P relating to cutting and pasting of images in the photo editing application program to the user via link 142.

In one embodiment a Bayesian optimization algorithm selects the preferred content to push to a user based upon the content of the user profile 120, group characteristics file 122, training system monitoring file 124 and application monitoring file 126. The system 119 is adaptive and constantly evolves as it is used and as new information is provided. The system 119 customizes training content to the individual user and, as the user's proficiency improves, the content provided matches the user's new skill level. The training system monitoring file 124 enables the system 119 to adapt to the actual needs of users by assessing whether the content is used, if the content is helpful in improving a user's proficiency and how the content can be improved. Over time, the system can eliminate unhelpful content and can be used to suggest areas where content is needed and how content can be improved to better serve users. The application monitoring file 126 enables the system 119 to make real-time assessments of a user's proficiency. Such eliminates the need for proficiency testing and enables the system 119 to make accurate assessments as to the efficacy of the training content offered; if the content improves proficiency, it is helpful, if not, the content should be modified or eliminated.

The above describes aspects of the present invention. One of ordinary skill of the art reviewing this description of the invention will understand that several variations are possible to perform the claimed invention. Different features, for example, may be the subject of training content offered. Different parameters may be utilized to determine whether the contents can be pushed to the individual user or not. For example, in some settings it may be appropriate to weigh a variety of factors to determine whether pushing the content to the individual user would be appropriate. One of ordinary skill in the art would readily recognize that the content or number of any file or database can be changed without departing from the spirit of the invention disclosed. For example, aspects of the user profile described above could be incorporated in the general profile and deleted from the personal profile. As noted above, the processor performing the steps of the invention could be located in a single user station 10 and the content library 14, user profile 16 and group profile 18 could also form part of the same user station 10.

We claim:

1. A training system comprising:
a monitoring function used in conjunction with an application program, said monitoring function being capable of identifying features of said application program that are utilized;
a programmed processor in electronic communication with said monitoring function such that data gathered by said monitoring function is conveyed to said programmed processor;
an electronic training library accessible by said programmed processor, said electronic training library containing content relating to use of said application program features, said programmed processor being capable of selecting said content from said training library at least in part, on said data, said programmed processor being capable of causing the electronic conveyance of said content to a user of said application program.

2. The system of claim 1 further comprising:
an electronic database containing information about the use of said application program by multiple users; said programmed processor capable of selecting said content from said training library based, at least in part, on said information.

3. The system of claim 1 further comprising:
a user profile, said user profile comprising facts about a specific user, said programmed processor capable of selecting said content from said training library based, at least in part, on said facts.

4. The system of claim 3 wherein:
said programmed processor being capable of updating said user profile with new facts about said specific user's interaction with said application program.

5. The system of claim 3 wherein:
said programmed processor being capable of updating said user profile with new facts about said specific user's interaction with said training library.

6. The system of claim 1 wherein:
said content includes a plurality of video presentations.

7. The system of claim 1 wherein:
said monitoring function is an add-in.

8. A training system comprising:
an application program;
a programmed processor;
a user profile, said user profile comprising facts about a specific user; and
a training library accessible by said programmed processor, said training library containing content relating to use of said application program, said programmed processor being capable of selecting said content from said training library based, at least in part, on said facts, said programmed processor being capable of electronically conveying said content to a user of said application program.

9. The system of claim 8 additionally comprising:
a general user database containing information about the use of said application program by multiple users; said programmed processor capable of selecting said content from said training library based, at least in part, on said information, said programmed processor being capable of electronically conveying said content to a user of said application program.

10. The system of claim 8 additionally comprising:
a monitoring function, said monitoring function tracking features of said application program that are utilized and being capable of conveying data relating to said tracked features to said programmed processor, said programmed processor being capable of selecting said content from said training library based, at least in part, on said data.

11. The system of claim 9 wherein:
a monitoring function, said monitoring function tracking features of said application program that are utilized and being capable of conveying data relating to said tracked features to said programmed processor; and
said programmed processor being capable of selecting said content from said training library based, at least in part, on said data, said programmed processor being capable of electronically conveying said content to said user.

12. The system of claim 8 wherein:
said content includes a plurality of video presentations.

13. A training method comprising the steps of:
electronically monitoring the use of an application program to identify use patterns of said application program;
using a programmed processor to utilize said identified use patterns to select content from an electronic training library, said content relating to said application program, said content usable to train a user of said application program to better utilize features of said application program; and
electronically conveying said selected content from said electronic training library, said conveyed selected content being presented to said user of said application program such that said conveyed selected content may be used to train said user to better utilize said features of said application program.

14. The training method of claim 13 wherein:
said content includes a plurality of video presentations.

15. The training method of claim 14 additionally comprising the step of:
using said programmed processor to utilize demographic information about said user to select content from said electronic training library.

16. The training method of claim 15 additionally comprising the step of:
using said programmed processor to utilize a general user database to select content from said electronic training library.

17. A training method comprising the steps of:
organizing an electronic training library, said electronic training library containing content relating to an application program, said content usable to train a user of said application program to better utilize features of said application program; and
electronically conveying said content to a user, said conveyed content having been selected from said electronic training library by a programmed processor, said programmed processor utilizing information about a user's interaction with said application program to make said selection of said conveyed content from said electronic training.

18. The system of claim 8 wherein:
said user may access said electronic training library from said application program.

19. The system of claim 8 wherein:
said facts include information about a user's employment responsibilities.

20. The system of claim 9 wherein:
said information includes evaluations of said content previously conveyed to said multiple users.

21. The system of claim 9 wherein:
said information includes the history of said multiple user's use of said content.

22. The system of claim 18 wherein:
said programmed processor may provide said user information about content currently being viewed by other users.

23. The system of claim 18 wherein:
said user may suggest content to other users of said application program through said programmed processor.

24. The system of claim 1 wherein:
said data is used to assess said user's proficiency with said application program.

25. The system of claim 24 wherein:
said data is used assess the efficacy of the content provided.

26. A training system comprising:
a defined electronic library containing training content useful for training an application program user on the use of said application program, said library being simultaneously and remotely accessible by a plurality of said application program users;
a programmed processor capable of monitoring said plurality of said application program user's access to said content, said monitoring used to define said content presented to said application program user; and
a user interface permitting said application program user to request and view said content from said application program.

27. The training system of claim 26 wherein:
said user interface is an add-in to said application program.

28. The training system of claim 26 wherein:
said monitoring is used to inform said application program user of said plurality of said application program user's interaction with said content.

29. The training system of claim 26 wherein:
said monitoring is used to inform said application program user of content previously viewed by said application program user.

30. The training system of claim 26 wherein:
said interface permits said user to request development of new content.
